(19) United States
(12) Patent Application Publication
(10) Pub. No.: US 2012/0245791 A1
(43) Pub. Date: Sep. 27, 2012

(54) APPARATUS AND METHOD FOR PREDICTING MIXED PROBLEMS WITH VEHICLE

(75) Inventors: Un-Il Yun, Cheongju (KR); Shin-Kyung Lee, Daejeon (KR); Hyeon-Il Shin, Cheongju (KR); Gwang-Bum Pyun, Cheongju (KR); Jeong-Woo Lee, Daejeon (KR); Oh-Cheon Kwon, Suwon (KR); Hyun-Seo Oh, Daejeon (KR); Heung-Mo Ryang, Cheongju (KR)

(73) Assignees: Chungbuk National University Industry-Academic Cooperation Foundation, Cheongju (KR); Electronics and Telecommunications Research Institute, Daejeon (KR)

(21) Appl. No.: 13/284,780

(22) Filed: Oct. 28, 2011

(30) Foreign Application Priority Data
Mar. 22, 2011 (KR) 10-2011-0025497

(51) Int. Cl. G06F 7/00

(52) U.S. Cl. 701/31.9

(57) ABSTRACT

The apparatus includes a data normalization unit, a neural network problem prediction unit, and a transition change prediction unit. The data normalization unit creates normalization transformation values by performing normalization transformation based on threshold value ranges for a plurality of pieces of vehicle network data. The neural network problem prediction unit creates a neural network problem prediction value by predicting a mixed problem with the vehicle using a multi-artificial neural network model, created based on a learning data set related to mixed problems having previously occurred in the vehicle and the normalization transformation values. The transition change prediction unit predicts a change in transition for the mixed problem according to a change in the neural network problem prediction value, by analyzing the neural network problem prediction value and previous neural network problem prediction values previously created in the vehicle.

### CROSS REFERENCE TO RELATED APPLICATION

This application claims the benefit of Korean Patent Application No. 10-2011-0025497, filed on Mar. 22, 2011, which is hereby incorporated by reference in its entirety into this application.

### BACKGROUND OF THE INVENTION

1. Technical Field

The present invention relates generally to an apparatus and method for predicting mixed problems with a vehicle and, more particularly, to an apparatus and method for predicting changes in transition for the problematic states of a vehicle attributable to combinations of causes using a multi-artificial neural network and a regression analysis method, which are data mining techniques.

2. Description of the Related Art

When the recent change of vehicles from mechanical apparatuses to electronic apparatuses, there is increasing interest in the application of an electronic control system in order to develop vehicles into more secure and efficient transportation means.

In a vehicle to which such an electronic control system has been applied, data is measured using sensors which are installed in component devices around an engine. Using the measured data, the vehicle is controlled or the problems of the vehicle are diagnosed. Furthermore, it may be possible to send measured data to a remote server via a remote terminal device installed in a vehicle and to then manage vehicle information or remotely make a diagnosis.

When information about an individual vehicle is managed as described above, the maintenance of the vehicle can be performed efficiently, and the information can be utilized in various fields related to the operation of the vehicle such as automobile insurance, logistics, traffic and environmental fields. Furthermore, when a problem occurs in a vehicle, the problem can be remotely diagnosed and then countermeasures can be taken, so that the problem with the vehicle can be rapidly dealt with and, therefore, the safety of the vehicle can improved and also the toll of lives can be reduced.

However, the technology for predicting future problems with a vehicle by analyzing the internal network data is limited to the diagnosis and prediction of a problem with a specific device of a vehicle. That is, the current technology for predicting a problem with a vehicle is used only to predict a problem with a specific device and the life span of a specific device, such as the life span of a battery or the vehicle, but cannot accurately predict problems with a vehicle attributable to combinations of causes, which result from pluralities of devices.

### SUMMARY OF THE INVENTION

Accordingly, the present invention has been made keeping in mind the above problems occurring in the prior art, and an object of the present invention is to provide an apparatus and method for predicting and providing the problems of a vehicle attributable to combinations of causes.

In order to accomplish the above object, the present invention provides an apparatus for predicting mixed problems with a vehicle, including a data normalization unit for creating normalization transformation values by performing normalization transformation based on threshold value ranges for a plurality of pieces of vehicle network data, transferred by the vehicle; a neural network problem prediction unit for creating a neural network problem prediction value by predicting a mixed problem with the vehicle using a multi-artificial neural network model, created based on a learning data set related to mixed problems having previously occurred in the vehicle and the normalization transformation values; and a transition change prediction unit for predicting a change in transition for the mixed problem according to a change in the neural network problem prediction value, by analyzing the neural network problem prediction value and previous neural network problem prediction values previously created in the vehicle.

The apparatus may further include a prediction result analysis unit for determining whether to immediately provide notification of the mixed problem or to predict the change in transition depending on results of comparison between the neural network problem prediction value and a reference problem value range.

The prediction result analysis unit may immediately provide notification of the mixed problem when the neural network problem prediction value exceeds a reference problem value range; and transfer the neural network problem prediction value to the transition change prediction unit when the neural network problem prediction value includes within the reference problem value range.

The multi-artificial neural network model may include an input layer, a hidden layer, and an output layer; and the neural network problem prediction unit may set an input weight of artificial neural network nodes between the input layer and the hidden layer, and creates the multi-artificial neural network model by learning the hidden layer based on the learning data set.

The hidden layer may create the neural network problem prediction value in accordance with the relationship between the normalization transformation values based on the learning data set.

The threshold value ranges is set to values between a minimum threshold value and a maximum threshold value; and the data normalization unit may perform normalization transformation of a vehicle network data into a first value when the vehicle network data is the minimum threshold value or the maximum threshold value, and perform normalization transformation of the vehicle network data into a second value different from the first value when the vehicle network data is a mid-value between the minimum and maximum threshold values.

The data normalization unit may perform normalization transformation into a third value larger than the second value and smaller than the first value when the vehicle network data is larger than the minimum threshold value and smaller than the mid-value or when the vehicle network data is larger than the mid-value and smaller than the maximum threshold value.

In order to accomplish the above object, the present invention provides a method of predicting mixed problems with a vehicle, including creating a multi-artificial neural network model based on a learning data set related to mixed problems having previously occurred in the vehicle; creating normalization transformation values based on threshold value ranges for a plurality of pieces of vehicle network data transferred by the vehicle; creating a neural network problem prediction value by predicting a mixed problem with the vehicle using the multi-artificial neural network model and the normalization transformation values; and determining whether to immediately provide notification of the mixed problem or to predict the change in transition change depending on results of comparison between the neural network problem prediction value and a reference problem value range.

The creating a multi-artificial neural network model may include setting an input weight of artificial neural network nodes between an input layer and a hidden layer included the multi-artificial neural network; and creating the multi-artificial neural network model by learning the hidden layer based on the learning data set.

The creating a neural network problem prediction value may include applying the input weight of the artificial neural network nodes to the normalization transformation values transferred to the input layer, and transferring a resulting value to the hidden layer; and creating the neural network problem prediction value in accordance with a relationship between the normalization transformation values,based on the learning data set.

The creating a normalization transformation values may include performing normalization transformation of a vehicle network data into a first value when the vehicle network data is a minimum or maximum threshold value of the threshold value ranges; and performing normalization transformation of the vehicle network data into a second value different from the first value when the vehicle network data is a mid-value between the minimum and maximum threshold values.

The creating a normalization transformation values may include performing normalization transformation into a third value larger than the second value and smaller than the first value when the vehicle network data is larger than the minimum threshold value and smaller than the mid-value or when the vehicle network data is larger than the mid-value and smaller than the maximum threshold value.

The determining whether to predict the change in transition change may include immediately providing notification of the mixed problem when the neural network problem prediction value exceeds the reference problem values; and predicting a change in transition for the mixed problem according to a change in the neural network problem prediction value, when the neural network problem prediction value includes within the reference problem value range used to predict the change in transition for the mixed problem.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram schematically illustrating a general apparatus for predicting the problems of a vehicle;

FIG. 2 is a drawing illustrating an example of a reference abnormality point at which an abnormal state is statistically reached;

FIG. 3 is a diagram schematically illustrating an apparatus for predicting the problems of a vehicle according to an embodiment of the present invention;

FIG. 4 is a table illustrating an example of vehicle network data according to an embodiment of the present invention;

FIG. 5 is a diagram schematically illustrating normalization transformation according to an embodiment of the present invention;

FIG. 6 is a diagram illustrating an example in which a multi-artificial neural network according to an embodiment of the present invention is constructed;

FIG. 7 is a diagram illustrating an example in which mixed problems with a vehicle are predicted in the vehicle equipped with the apparatus for predicting mixed problems with a vehicle shown in FIG. 3; and

FIG. 8 is a flowchart illustrating the process of predicting the mixed problem with a vehicle in the apparatus for predicting mixed problems with a vehicle shown in FIG. 3.

### DESCRIPTION OF THE PREFERRED EMBODIMENTS

Reference now should be made to the drawings, throughout which the same reference numerals are used to designate the same or similar components.

The present invention will be described in detail below with reference to the accompanying drawings. Repetitive descriptions and descriptions of known functions and constructions which have been deemed to make the gist of the present invention unnecessarily vague will be omitted below. The embodiments of the present invention are provided in order to fully describe the present invention to a person having ordinary skill in the art. Accordingly, the shapes, sizes, etc. of elements in the drawings may be exaggerated to make the description clear.

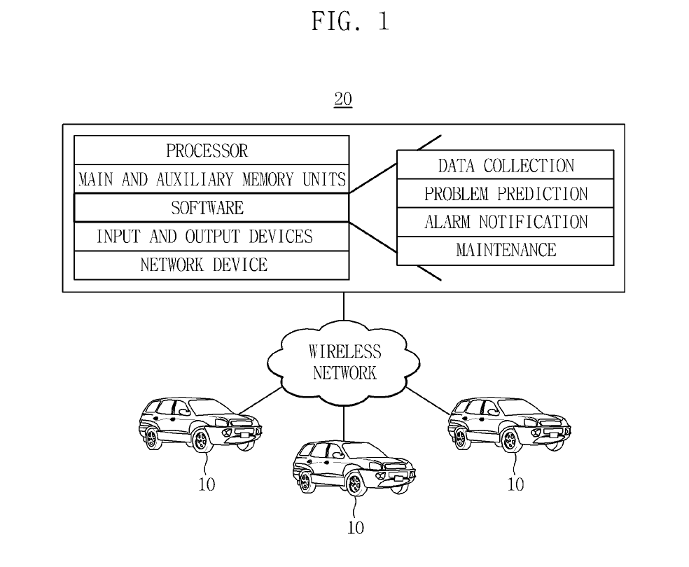

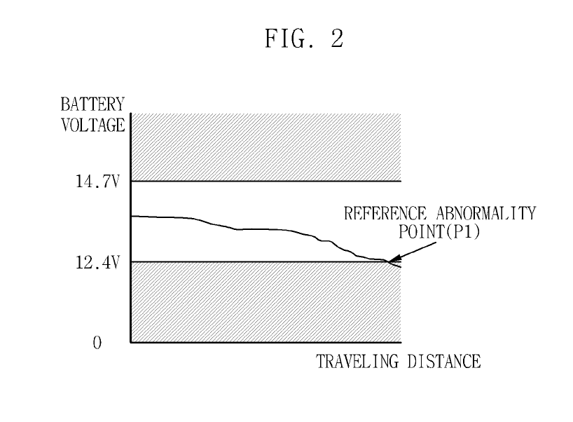

FIG. 1 is a diagram schematically illustrating a general apparatus for predicting the problems of a vehicle 20. FIG. 2 is a drawing illustrating an example of a reference abnormality point at which an abnormal state is statistically reached.

Referring to FIGS. 1 and 2, the general apparatus 20 for predicting problems with vehicles 10 periodically measures the internal data of a vehicle, such as the traveling distances of the vehicles, changes in oil pressure over time, and battery voltage. Furthermore, the general apparatus 20 predicts a reference abnormality point P1 at which each of the component devices that constitute a vehicle statistically reaches an abnormal state using the internal data of the vehicle, and provides the reference point P1.

The above prediction method is a simple method that is used to predict a problem with a specific device or the lifespan of an expendable part. This method is problematic in that it is impossible to predict problems and abnormal states that occur due to combinations of causes and the relationship between the component devices of each vehicle.

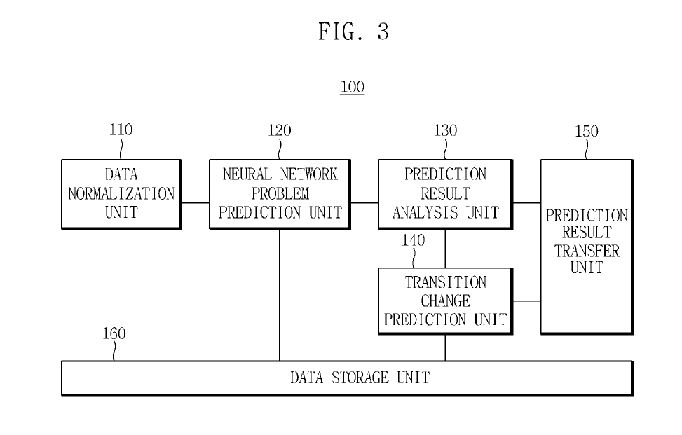

An apparatus 100 for predicting problems with a vehicle attributable to combinations of causes according to an embodiment of the present invention, which was devised to solve the above problem, will be described in detail with reference to FIGS. 3 to 8.

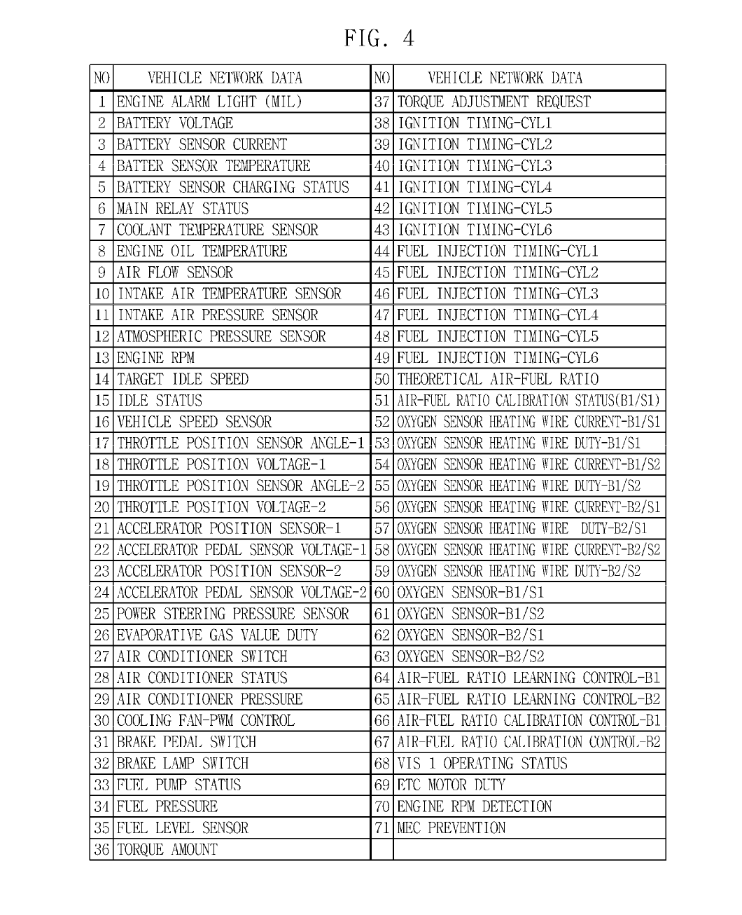

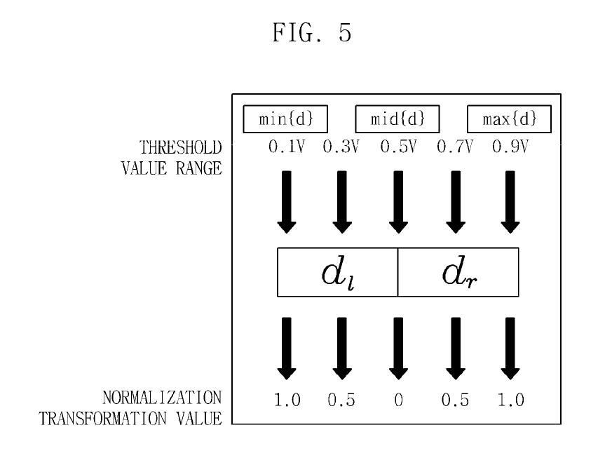

FIG. 3 is a diagram schematically illustrating the apparatus 100 for predicting the problems of a vehicle according to the embodiment of the present invention. FIG. 4 is a table illustrating an example of vehicle network data according to an embodiment of the present invention. FIG. 5 is a diagram schematically illustrating normalization transformation according to an embodiment of the present invention.

As shown in FIG. 3, the apparatus 100 for predicting the problems of a vehicle attributable to combinations of causes according to the embodiment of the present invention includes a data normalization unit 110, a neural network problem prediction unit 120, a prediction result analysis unit 130, a transition change prediction unit 140, a prediction result transfer unit 150, and a data storage unit 160.

The data normalization unit 110 periodically receives vehicle network data that is exchanged over the internal network of the vehicle. Here, the term “internal network” refers to the network inside a vehicle, which is used to transfer information among the electronic control devices of the vehicle, such as a CAN (Controller Area Network), K-LINE, LIN (Local Interconnect Network) and FlexRay. The data normalization unit 110 analyzes the vehicle network data, and then detects only a minimum amount of vehicle network data necessary to predict the problems of the vehicle attributable to combinations of causes (hereinafter referred to as “mixed problems”).

For example, the data normalization unit 110 detects only a minimum amount of vehicle network data necessary to determine the mixed problems with the vehicle because it is inefficient to determine the mixed problems with the vehicle using all of the pieces of engine sensor data shown in FIG. 4. Here, an example of mixed problems with a vehicle based on vehicle network data is shown in Table 1. That is, the data normalization unit 110 selects engine sensor data Nos. 2 to 5 as vehicle network data because it is possible to predict problems only using the status information of battery voltage because when the voltage of a battery decreases, the current and charging status thereof decrease as well. Meanwhile, the data normalization unit 110 does not select engine sensor data Nos. 38 to 43, that is, ignition point data, representative of the locations where the crank shaft of an engine reaches the ignition point because data represented using the angle and waveform is inappropriate to predicting problems because there is no threshold value in the data. Furthermore, the data normalization unit 110 does not select data adjusted by an Electronic Control Unit (ECU) for electronically controlling the engine of the vehicle because the data is inappropriate to predicting the problems because the data is adjusted in ratios.

TABLE 1

| | VEHICLE | |
|---|---|---|
| No | NETWORK DATA | POSSIBLE MIXED PROBLEMS |
| 1 | Battery voltage | shutdown of engine, excessive fuel |
| | | consumption, smoke |
| 2 | Coolant temperature | reduced power output, excessive fuel |
| | sensor | consumption |
| 3 | Air flow sensor | reduced power output, smoke |
| 4 | Throttle position | reduced power output, shutdown of engine, |
| | voltage | engine disorder |
| 5 | Accelerator pedal | brake system |
| | sensor voltage | |
| 6 | Air conditioner | shutdown of engine, air conditioner |
| | pressure | |
| 7 | Oxygen sensor | abnormal engine, reduced power output, smoke |
| 8 | Air-fuel ratio | excessive fuel consumption, smoke |
| | learning control | |

Furthermore, the data normalization unit 110 sets up a restrictive condition related to each threshold value range and then performs normalization transformation because a plurality of pieces of vehicle network data selected to predict the problems of the vehicle have different types of numeral values and units. The data normalization unit 110 determines that a state in question is normal if corresponding vehicle network data falls between a minimum threshold value and a maximum threshold value during normalization transformation, and determines that the state is an abnormal state (problematic state) if the value does not fall within the threshold range. That is, in this embodiment of the present invention, whether a state is abnormal is determined using a data mining prediction technique, so that the units of the data are converted into the same unit and then the relationship between the pieces of data is taken into account so as to utilize the prediction technique. Here, each threshold value is a value that is used to set the boundary between normality and abnormality, is defined as a value between the minimum threshold value and the maximum threshold value, and is set depending on vehicle network data. Accordingly, threshold values have different types of numerical values and units.

In detail, the data normalization unit 110 defines a normalization transformation value for a minimum threshold value Min and a maximum threshold value Max from which a problematic state starts as “1,” and defines the normalization transformation value for a mid-value in the threshold value ranges, as shown in FIG. 5. Furthermore, the data normalization unit 110 performs normalization transformation on each piece of vehicle network data in accordance with a set threshold value ranges. That is, the data normalization unit 110 performs normalization transformation so that when battery voltage data is closer to the minimum threshold value Min or maximum threshold value Max, the normalization transformation value for the battery voltage data becomes closer to “1.” Furthermore, the data normalization unit 110 performs normalization transformation so that the normalization transformation value for the mid-value mid of the threshold value ranges becomes closer to “0.”

In order to normalize the vehicle network data as described above, the data normalization unit 110 performs normalization transformation using Equation 1 when the value of vehicle network data falls between the minimum threshold value min and the mid-value mid of the threshold value ranges. Furthermore, the data normalization unit 110 performs normalization transformation using Equation 2 when the value of vehicle network data falls between the mid-value mid of the threshold value ranges and the maximum threshold value max.

$$\begin{matrix}{d}_{l} = \frac{mid \{ d \} - {d}_{l}}{mid \{ d \} - min \{ d \}} & ( 1 ) \\ {d}_{r} = \frac{{d}_{r} - mid \{ d \}}{max \{ d \} - min \{ d \}} & ( 2 )\end{matrix}$$

For example, when the minimum and maximum threshold values for battery voltage data is “0.1 V” and “0.9 V,” respectively, a state is set as a normal state when a corresponding value falls within a threshold value ranges of 0.1 V-0.9 V, and a state is set as a problematic state when a corresponding value is smaller than minimum threshold value 0.1 V or larger than maximum threshold value 0.9 V, the data normalization unit 110 performs normalization transformation on the battery voltage data by applying minimum threshold value (min) “0.1V′, the mid-value (mid) “0.5 V” of the threshold value ranges obtained by adding the minimum threshold value and the maximum threshold value and dividing the sum by 2, and maximum threshold value (max) “0.9 V” to Equations 1 and 2. That is, when the battery voltage data is “0.7V,” the data normalization unit 110 converts the normalization transformation value into “0.5” using Equation 2. When the battery voltage data is “0.8V,” the data normalization unit 110 converts the normalization transformation value into “0.75” using Equation 2. Furthermore, when the battery voltage data is “0.23V,” the data normalization unit 110 converts the normalization transformation value into “0.325” using Equation 1.

Referring back to FIG. 3 again, the neural network problem prediction unit 120 performs modeling by causing a multi-artificial neural network model to be learned in accordance with the characteristics of a vehicle model in order to predict the problems of the vehicle. Furthermore, the neural network problem prediction unit 120 receives a normalization transformation values from the data normalization unit 110, and predicts the mixed problems of the vehicle by inputting the normalization transformation values to the multi-artificial neural network model formed in accordance with the characteristics of the vehicle model, thereby creating a neural network problem prediction value. Furthermore, the neural network problem prediction unit 120 transfers the neural network problem prediction value to the prediction result analysis unit 130. The neural network problem prediction unit 120 stores the neural network problem prediction value, created in accordance with the normalization transformation values, in the data storage unit 160 in time sequence. A detailed description of the multi-artificial neural network model according to an embodiment of the present invention will be given later.

The prediction result analysis unit 130 predicts the problems of the vehicle based on the neural network problem prediction value. That is, the prediction result analysis unit 130 immediately notifies a driver and an administrator of a danger via the prediction result transfer unit 150 when the occurrence of a problem is definite because the probability of the neural network problem prediction value for a corresponding problem is higher than a reference problem value range as a result of the analysis of the neural network problem prediction value. In contrast, the prediction result analysis unit 130 transfers the neural network problem prediction value to the transition change prediction unit 140 so as to predict a transition change for a corresponding problem when the probability of the problem prediction value is lower than the reference problem value range as a result of the analysis of the neural network problem prediction value.

The transition change prediction unit 140 receives the neural network problem prediction value from the prediction result analysis unit 130 so as to predict a change in transition for a corresponding problem. The transition change prediction unit 140 retrieves the previous neural network problem prediction value of the corresponding vehicle from the data storage unit 160 in order to perform regression analysis on a corresponding neural network problem prediction value. That is, the transition change prediction unit 140 performs regression analysis using an equation in which a neural network problem prediction value is calculated using a method of least squares for each time. The transition change prediction unit 140 predicts a change in transition for the corresponding problem using a graph illustrating the results of the regression analysis using the equation. The transition change prediction unit 140 notifies a driver and an administrator of a danger via the prediction result transfer unit 150 based on the results of the prediction of the corresponding change in transition change because the probability of the corresponding problem occurring is higher than the reference problem value range when one gets closer to a specific time range, that is, a time period in which the corresponding problem will occur.

The prediction result transfer unit 150 notifies the driver and the administrator of the results of the prediction of the corresponding problem transferred by the prediction result analysis unit 130 and the transition change prediction unit 140.

The data storage unit 160 stores information about the overall status of the vehicle that is used to determine whether the vehicle has a problem. For example, the data storage unit 160 stores the time-based neural network problem prediction value of the corresponding vehicle necessary for regression analysis, and stores the previous time-based neural network problem prediction values of the corresponding vehicle in response to the request from the transition change prediction unit 140.

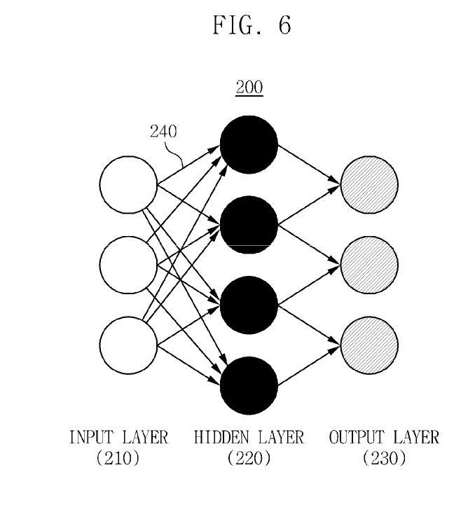

FIG. 6 is a diagram illustrating an example in which a multi-artificial neural network according to an embodiment of the present invention is constructed.

As shown in FIG. 6, a neural network problem prediction unit 120 according to an embodiment of the present invention constructs a multi-artificial neural network model 200 including an input layer 210, a hidden layer 220, and an output layer 230. A learning data set necessary for learning according to an embodiment of the present invention is a set of normalization transformation values that are obtained by collecting vehicle network data occurring in each problematic state in models identical to the corresponding vehicle in advance and normalizing the vehicle network data. The neural network problem prediction unit 120 sets the input weight 240 of a neural network node to an optimum value using the learning data set

Specifically, the neural network problem prediction unit 120 sets the input weight 240 of the perceptron-structured artificial neural network nodes between the input layer 210 and the hidden layer 220. Furthermore, the neural network problem prediction unit 120 transfers the normalization transformation values, transferred to the input layer 210, to the hidden layer 220 using a sigmoid function as the transfer function. The neural network problem prediction unit 120 causes the hidden layer 220 of the multi-artificial neural network to learn normalization transformation value “1” in the case where the corresponding vehicle has a problem and normalization transformation value “0” in the case where the corresponding vehicle is normal based on the learning data set. In this case, information about problems that have previously occurred in the corresponding vehicle is learned by the hidden layer 220 using error back-propagation.

Once the construction of the multi-artificial neural network model 200 has been completed, the neural network problem prediction unit 120 applies the weight 240 of the neural network nodes to the normalization transformation values input via the input layer 210, and then transfers a resulting value to the hidden layer 220. The neural network problem prediction unit 120 transfers neural network problem prediction values for the problematic states of a specific vehicle, created in accordance with the relationship between the normalization transformation values at the hidden layer 220, via the output layer 230. In this case, with regard to the neural network problem prediction values, since the probability of the corresponding vehicle being in a normal state or in an abnormal state is represented using a value between “0” and “1,” the neural network problem prediction unit 120 determines that the probability of a problem occurring is higher when the neural network problem prediction value is closer to “1,” and determines that the probability of a problem occurring is definite when the neural network problem prediction value is equal to or larger than “1.”

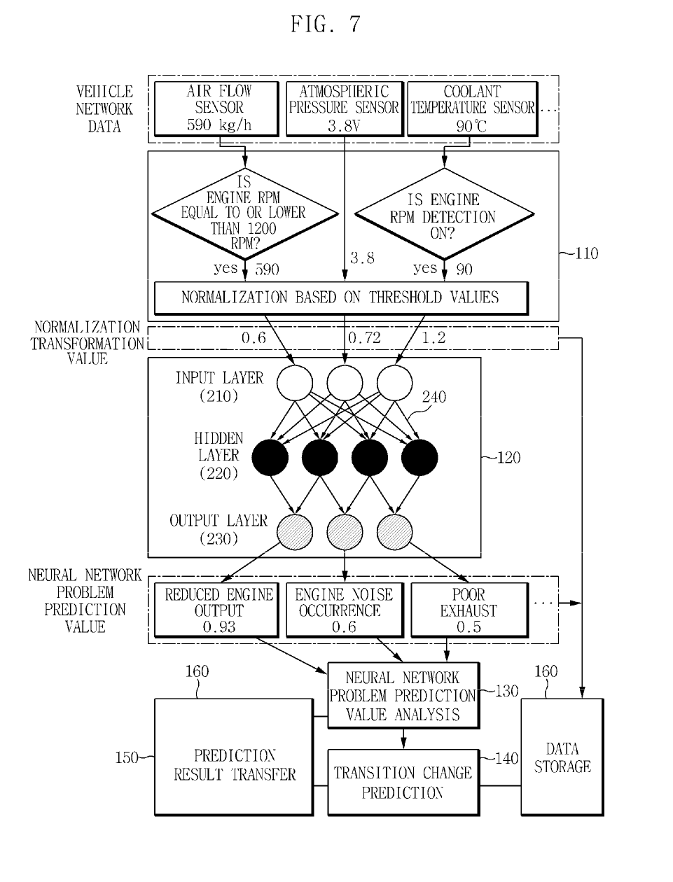

FIG. 7 is a diagram illustrating an example in which mixed problems with a vehicle are predicted in the vehicle equipped with the apparatus for predicting mixed problems with a vehicle shown in FIG. 3.

As shown in FIG. 7, according to an embodiment of the present invention, in order to predict mixed problems with a vehicle, the data normalization unit 110 of the apparatus 100 for predicting mixed problems with a vehicle sets up restrictive conditions, which influence the threshold values of the vehicle network data, suitable for a vehicle model prior to causing the multi-artificial neural network to learn. An example of such threshold values is shown in Table 2. Furthermore, the neural network problem prediction unit 120 performs modeling by causing the multi-artificial neural network model to learn in accordance with the characteristics of the problem based on the learning data set in accordance with the model of the corresponding vehicle that predicts the mixed problems.

TABLE 2

| | VEHICLE | |
|---|---|---|
| No | NETWORK DATA | THRESHOLD VALUES |
| 1 | Battery voltage | lower than 12.4 V, or higher than 14.7 V |
| 2 | Coolant temperature | lower than 20° C., or higher than 80° C. |
| | sensor | |
| 3 | Air flow sensor | lower than 3 kg/h, or higher than 700 kg/h |
| 4 | Throttle position | lower than 0.14 V, or higher than 4.85 V |
| | voltage | |
| 5 | Accelerator pedal | lower than 750 mV, or higher than 750 mV |
| | sensor voltage | |
| 6 | Air conditioner | equal to or higher than 3115 kPa |
| | pressure | |
| 7 | Oxygen sensor | lower than 0.1 V, or higher than 0.9 V |
| 8 | Air-fuel ratio | lower than 80%, or higher than 120% |
| | learning control | |

Once the multi-artificial neural network structure has been constructed as described above, the data normalization unit 110 creates the normalization transformation values by performing normalization transformation on vehicle network data, transferred by a currently traveling vehicle, whose mixed problems will be predicted, in a specific time, based on threshold value ranges.

For example, when the vehicle network data is air flow sensor data (590 kg/h), atmospheric pressure sensor data (3.8 V) and coolant temperature sensor data (90° C.), the data normalization unit 110 creates normalization transformation value “0.6” by performing normalization transformation based on the threshold value because the air flow sensor data (590 kg/h) indicates a normal status under the restrictive condition that the rpm of the engine of the corresponding vehicle is equal to or smaller than 1200 rpm. Assuming that the atmospheric pressure sensor has no restrictive condition, the data normalization unit 110 creates normalization transformation value “0.72” by performing normalization transformation on the atmospheric pressure sensor data (3.8 V), which does not exceed the threshold value, based on the threshold values. Assuming that the coolant temperature sensor data has the restrictive condition that the rpm of an engine is detected, the data normalization unit 110 creates normalization transformation value “1.2” by performing normalization transformation based on threshold values because the coolant temperature sensor data (90° C.) exceeds the maximum threshold value 80° C.

The neural network problem prediction unit 120 receives a normalization and transformation value from the data normalization unit 110. The neural network problem prediction unit 120 creates a neural network problem prediction value by inputting the normalization transformation values to a multi-artificial neural network model constructed to be suitable for the characteristics of the vehicle model and predicting a mixed problem with the vehicle. For example, when normalization transformation value “0.6” is input for air flow sensor data, the input layer 210 of the neural network problem prediction unit 120 applies the weight 240 of the neural network nodes to normalization transformation value “0.6” for the air flow sensor data and transfers a resulting value to the hidden layer 220. Then, the hidden layer 220 transfers a neural network problem prediction value for a reduction in engine output predicted based on the air flow sensor data, that is, engine output reduction value “0.93,” to the prediction result analysis unit 130 via the output layer 230, based on the probability of a learning data set, which is information about the problems having previously occurred in the corresponding vehicle.

Depending on the results of the comparison between the neural network problem prediction value and the reference problem value, the prediction result analysis unit 130 may immediately notify a driver and an administrator of a danger via the prediction result transfer unit 150, or may transfer the neural network problem prediction value to the transition change prediction unit 140 in order to predict a change in transition for the corresponding problem.

For example, in the case where the reference problem value range for the immediate notification of the occurrence of a problem is equal to or larger than “0.9” and the reference problem value range for the prediction of a change in transition for the corresponding problem using regression analysis is between “0.8” and “0.9,” when the neural network problem prediction value “0.93” for the reduction in engine output is transferred, the prediction result analysis unit 130 compares neural network problem prediction value “0.93” with reference problem value range “0.9.” When neural network problem prediction value “0.93” is larger than reference problem value range “0.9” as a result of the comparison, the prediction result analysis unit 130 immediately provides a danger signal representative of the impending occurrence of a problem via the prediction result transfer unit 150. In this case, since the corresponding problem are problems in that the importance of the neural network problem prediction value “0.6” for the occurrence of engine noise and the importance of neural network problem prediction value “0.5” for poor exhaust are low and the reference problem value range for the prediction of a change in transition for the corresponding problem using regression analysis does not exceed “0.8,” a change in transition is not predicted.

Meanwhile, when another neural network problem prediction value related to a danger or a problem of high importance is between “0.8” and “0.9,” the prediction result analysis unit 130 transfers the corresponding neural network problem prediction value to the transition change prediction unit 140 in order to predict when the corresponding important problem will reach the reference problem value range “0.9.” Then, the transition change prediction unit 140 retrieves the previous neural network problem prediction values of the corresponding vehicle from the data storage unit 160 so as to perform regression analysis on a corresponding neural network problem prediction value, and then predicts a change in transition.

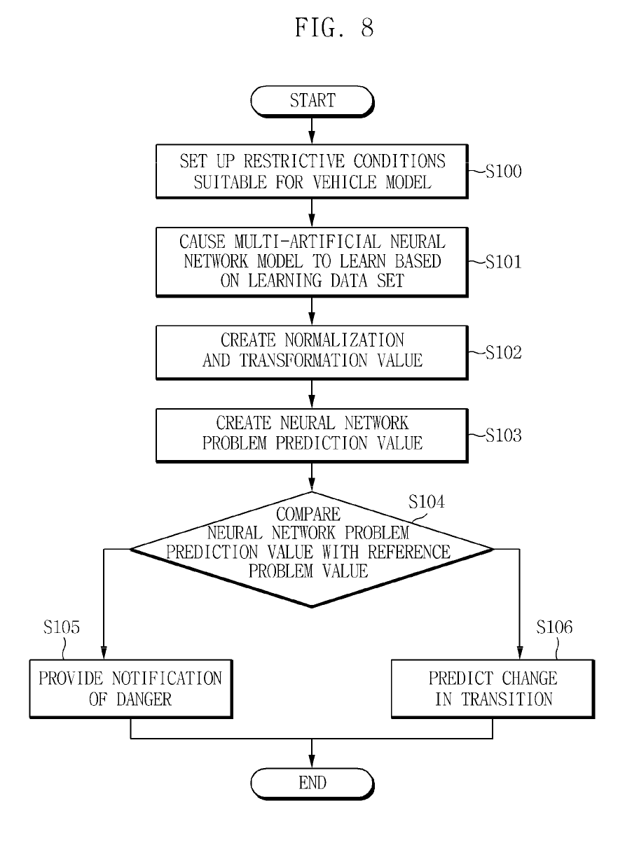

FIG. 8 is a flowchart illustrating the process of predicting a mixed problem with a vehicle in the apparatus 100 for predicting mixed problems with a vehicle shown in FIG. 3.

As shown in FIG. 8, at step S100, the data normalization unit 110 of the apparatus 100 for predicting the problems of a vehicle according to the embodiment of the present invention sets up restrictive conditions, which influence the threshold values of vehicle network data, in accordance with a vehicle model prior to causing a multi-artificial neural network to learn. At step S101, the neural network problem prediction unit 120 causes a multi-artificial neural network model to learn based on a learning data set in accordance with the model of the corresponding vehicle whose mixed problems will be predicted.

Once the multi-artificial neural network structure has been constructed at steps S100 and S101, the data normalization unit 110 creates a normalization and transformation value by performing normalization transformation on vehicle network data transferred by a currently traveling vehicle, whose mixed problems will be predicted, at a specific time depending on a threshold value ranges at step S102. The data normalization unit 110 transfers the normalization and transformation value to the neural network problem prediction unit 120.

The neural network problem prediction unit 120 creates a neural network problem prediction value by inputting the normalization transformation values to the multi-artificial neural network model and predicting a mixed problem with the vehicle at step S103. The neural network problem prediction unit 120 transfers the neural network problem prediction value to the prediction result analysis unit 130.

The prediction result analysis unit 130 compares the neural network problem prediction value with the reference problem value range at step S104. The prediction result analysis unit 130 may immediate notify a driver and an administrator of a danger via the prediction result transfer unit 150, or may transfer the neural network problem prediction value to the transition change prediction unit 140 in order to predict a change in transition for the corresponding problem, depending on the results of the comparison. That is, when the neural network problem prediction value exceeds the reference problem value range for immediate notification of the impending occurrence of a problem, the prediction result analysis unit 130 immediately notifies a driver and an administrator of a danger via the prediction result transfer unit 150 at step S105.

Meanwhile, when the neural network problem prediction value falls within a reference problem value range used to predict a change in transition for the corresponding problem, the prediction result analysis unit 130 transfers the corresponding neural network problem prediction value to the transition change prediction unit 140 at step S105. The transition change prediction unit 140 retrieves the previous neural network problem prediction values of the corresponding vehicle from the data storage unit 160 so as to perform regression analysis on the corresponding neural network problem prediction value and then predicts a change in transition at step S106. That is, the transition change prediction unit 140 predicts when the corresponding neural network problem prediction value will reach the reference problem value range used to immediately provide notification of the impending occurrence of a problem.

As described above, in the embodiments of the present invention, a multi-artificial neural network is constructed by causing the multi-artificial neural network to learn in accordance with the characteristics of a vehicle model, neural network problem prediction values for the problematic states of a corresponding vehicle are created in accordance with the relationship between data by applying normalization and transformation values, obtained by performing normalization on the vehicle network data in accordance with threshold value ranges, to the multi-artificial neural network model, and then notification of a danger is immediately provided or a change in transition is predicted, so that mixed problems can be predicted and provided for by analyzing dangers which may occur between the components of a vehicle, thereby preventing accidents and protecting the lives of passengers.

Furthermore, in the embodiments of the present invention, the current status of a vehicle as well as mixed problems can be checked using the multi-artificial neural network learned in accordance with the characteristics of a vehicle model, so that the inefficiency of the use of fuel or the excessive discharge of exhaust gas, which may occur during the operation of the vehicle, can be detected, thereby contributing to the protection of environment and the conservation of energy, and so that the present invention can be utilized for the operation of the vehicle, the management of a history and the prevention of accidents in the fields of insurance and transportation.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for predicting mixed problems with a vehicle, comprising:
a data normalization unit for creating normalization transformation values by performing normalization transformation based on threshold value ranges for a plurality of pieces of vehicle network data transferred by the vehicle;
a neural network problem prediction unit for creating a neural network problem prediction value by predicting a mixed problem with the vehicle using a multi-artificial neural network model, created based on a learning data set related to mixed problems having previously occurred in the vehicle, and the normalization transformation values; and
a transition change prediction unit for predicting a change in transition for the mixed problem according to a change in the neural network problem prediction value, by analyzing the neural network problem prediction value and previous neural network problem prediction values previously created in the vehicle.

2. The apparatus as set forth in claim 1, further comprising a prediction result analysis unit for determining whether to immediately provide notification of the mixed problem or to predict the change in transition depending on results of comparison between the neural network problem prediction value and a reference problem value range.

3. The apparatus as set forth in claim 2, wherein the prediction result analysis unit:
immediately provides notification of the mixed problem when the neural network problem prediction value exceeds the reference problem value range; and
transfers the neural network problem prediction value to the transition change prediction unit when the neural network problem prediction value includes within the reference problem value range.

4. The apparatus as set forth in claim 2, wherein:
the multi-artificial neural network model comprises an input layer, a hidden layer, and an output layer; and
the neural network problem prediction unit sets an input weight of artificial neural network nodes between the input layer and the hidden layer, and creates the multi-artificial neural network model by learning the hidden layer based on the learning data set

5. The apparatus as set forth in claim 4, wherein the hidden layer creates the neural network problem prediction value in accordance with a relationship between the normalization transformation values based on the learning data set.

6. The apparatus as set forth in claim 4, wherein:
the threshold value ranges is set to values between a minimum threshold value and a maximum threshold value; and
the data normalization unit performs normalization transformation of a vehicle network data into a first value when the vehicle network data is the minimum threshold value or the maximum threshold value, and performs normalization transformation of the vehicle network data into a second value different from the first value when the vehicle network data is a mid-value between the minimum and maximum threshold values.

7. The apparatus as set forth in claim 6, wherein the data normalization unit performs normalization transformation into a third value larger than the second value and smaller than the first value when the vehicle network data is larger than the minimum threshold value and smaller than the mid-value or when the vehicle network data is larger than the mid-value and smaller than the maximum threshold value.

8. A method of predicting mixed problems with a vehicle, comprising.
creating a multi-artificial neural network model based on a learning data set related to mixed problems having previously occurred in the vehicle;
creating normalization transformation values based on threshold value ranges for a plurality of pieces of vehicle network data transferred by the vehicle;
creating a neural network problem prediction value by predicting a mixed problem with the vehicle using the multi-artificial neural network model and the normalization transformation values; and
determining whether to immediately provide notification of the mixed problem or to predict the change in transition change depending on results of comparison between the neural network problem prediction value and a reference problem value range.

9. The method as set forth in claim 8, wherein the creating a multi-artificial neural network model comprises:
setting an input weight of artificial neural network nodes between an input layer and a hidden layer included the multi-artificial neural network; and
creating the multi-artificial neural network model by learning the hidden layer based on the learning data set.

10. The method as set forth in claim 9, wherein the creating a neural network problem prediction value comprises:
applying the input weight of the artificial neural network nodes to the normalization transformation values transferred to the input layer, and transferring a resulting value to the hidden layer; and
creating the neural network problem prediction value in accordance with a relationship between the normalization transformation values based on the learning data set.

11. The method as set forth in claim 10, wherein the creating a normalization transformation values comprises:
performing normalization transformation of a vehicle network data into a first value when the vehicle network data is a minimum or maximum threshold value of the threshold value ranges; and
performing normalization transformation of the vehicle network data into a second value different from the first value when the vehicle network data is a mid-value between the minimum and maximum threshold values.

12. The method as set forth in claim 11, wherein the creating a normalization transformation values comprises performing normalization transformation into a third value larger than the second value and smaller than the first value when the vehicle network data is larger than the minimum threshold value and smaller than the mid-value or when the vehicle network data is larger than the mid-value and smaller than the maximum threshold value.

13. The method as set forth in claim 11, wherein the determining whether to predict the change in transition change comprises:
immediately providing notification of the mixed problem when the neural network problem prediction value exceeds the reference problem values; and
predicting a change in transition for the mixed problem according to a change in the neural network problem prediction value, when the neural network problem prediction value includes within the reference problem value range.
